(19) United States
(12) Patent Application Publication
(10) Pub. No.: US 2009/0067420 A1
(43) Pub. Date: Mar. 12, 2009

(54) Location Determination for a Packet-Switched Device for Providing Location-Based Services

(75) Inventors: Sathyam Ganesan, Holden, MA (US); Marie Jose Montpetit, Jamaica Plain, MA (US); Carlton J. Sparrell, Marblehead, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/853,354

(22) Filed: Sep. 11, 2007

(51) Int. Cl. H04L 12/56

(52) U.S. Cl. 370/389

(57) ABSTRACT

A device is operable to determine location of a packet-switched device, and the location is used to provide location-based services for the packet-switched device. The device includes an interface receiving a message. The message includes a tag inserted by an access point between the packet-switched device and the device. A database stores a plurality of tags and a location for each tag. The device parses the received message to identify the tag, and performs a lookup on the database using the tag to determine a corresponding location for the tag. This location is an estimation of a location of the packet-switched device, and the location is operable to be used to provide a location-based service for the packet-switched device.

### BACKGROUND

A telephone that operates using a traditional circuit-switched network, such as a public switched telephone network (PSTN), typically has a telephone number that is associated with the location of the telephone. For example, at a residence, if a telephone is replaced with a second telephone, the second telephone will have the same telephone number. In other words, the telephone number is essentially associated with the geographic location of the residence instead of the telephone. This makes providing location-based services, such as a “911” service, for the residence via the telephone much easier, because the telephone number is tied to a particular geographic location.

For example, a person at the residence calls “911”. The call is routed to a “911” call center based on the telephone number and a location of the residence determined from the telephone number. Then, emergency personnel are dispatched to that location.

Providing location-based services for devices that communicate via a packet-based network, such as Worldwide Interoperability for Microwave Access (WiMAX) or WiFi, has always posed a challenge, because these devices may use Internet Protocol (IP) addresses to identify the source and destination for a transmission in the network, and the IP addresses cannot easily be matched to geographic locations. For example, a voice-over-IP (VoIP) telephone is not easily associated with a geographic location. Unlike a conventional telephone using a PSTN, the telephone number for the VoIP telephone is tied to the telephone rather than a location. Thus, if the VoIP telephone is moved, for example, from a residence where the VoIP phone is primarily used to a new location, the location of the VoIP telephone may not be determined when calls are made from the VoIP telephone at the new location.

This poses a greater problem when mobile devices, such as VoIP mobile phones, laptops, personal digital assistants (PDAs), etc., which use a packet-switched network for communication, request a location-based service, such as an emergency service like “911”. As described above, mobile devices that use a packet-switched network may be identified by an IP address. However, the IP address may change in different sessions if it is dynamically assigned. Also, there is no way to identify the device's location based on its IP address. Thus, a user of a VoIP phone may be unable to receive “911” service or other location-based services.

### SUMMARY

According to an embodiment, a device is operable to determine a location of a packet-switched device, and the location may be used to provide location-based services for the packet-switched device. The device includes an interface receiving a message. The message includes a tag inserted by an access point between the packet-switched device and the device. The device also includes a processor parsing the message to identify the tag, and performing a lookup in a database using the tag to determine a corresponding location for the tag. The database stores a plurality of tags and a location for each tag. The location retrieved from the database is an estimation of a location of the packet-switched device, and the location is operable to be used to provide a location-based service for the packet-switched device.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates a system for providing location-based services for a packet-switched device, according to an embodiment;

FIGS. 2A-C illustrate examples of providing a tag in a message, according to embodiments;

FIG. 3 illustrates a system for providing “911” service, according to an embodiment;

FIG. 4 illustrates a flowchart of a method for providing location-based services, according to an embodiment; and

FIG. 5 illustrates a block diagram of a computer system, according to an embodiment.

### DETAILED DESCRIPTION

For simplicity and illustrative purposes, the principles of the embodiments are described by referring mainly to examples thereof. Numerous specific details are set forth in order to provide a thorough understanding of the embodiments. It will be apparent however, to one of ordinary skill in the art, that the embodiments may be practiced without limitation to many of these specific details. Also, in some instances, well known methods and structures are not described in detail so as not to unnecessarily obscure the description of the embodiments.

According to an embodiment, a system is operable to provide location-based services for packet-switched devices. Packet-switched devices are devices that use a packet-switched network to communicate with other devices. Examples of packet-switched devices may include mobile devices, such as laptops, PDAs, personal media players, mobile phones (e.g., VoIP phones), and non-mobile devices, such as personal computers, etc. A location-based service uses a geographic location, for example, of the service requestor, to provide a service. In the case of “911”, the service is provided to the geographic location. Other types of location-based services provide information to the service requester based on the geographic location of the requester. For example, this may include providing a list of restaurants, stores, etc., that are within a predetermined vicinity of a current location of a requester, or providing advertisements/promotions for businesses within the predetermined vicinity of the requester.

A packet-switched device uses IP addresses to identify a source and a destination. An IP address for a source typically cannot accurately be associated with a geographic location for providing location-based services. However, the locations of access points for packet-switched devices are typically known, especially when these access points are part of a planned deployment. For example, businesses that deploy access points at various locations to provide employees or customers with access to the Internet typically store the geographic locations of these access points. Also, an access point may be a residential gateway at a residence or an access point in a residence, and the address of the residence is known. According to an embodiment, a location of an access point used by a packet-switched device to access an IP network is used as an estimation of the location of the packet-switched device. According to an embodiment, when a packet-switched device communicates with another device or attempts to establish a session to communicate with another device via a packet-switched network, an access point inserts a tag in a message. This tag is associated with the predetermined location of the access point, and is used as an estimation of the location of the packet-switched device.

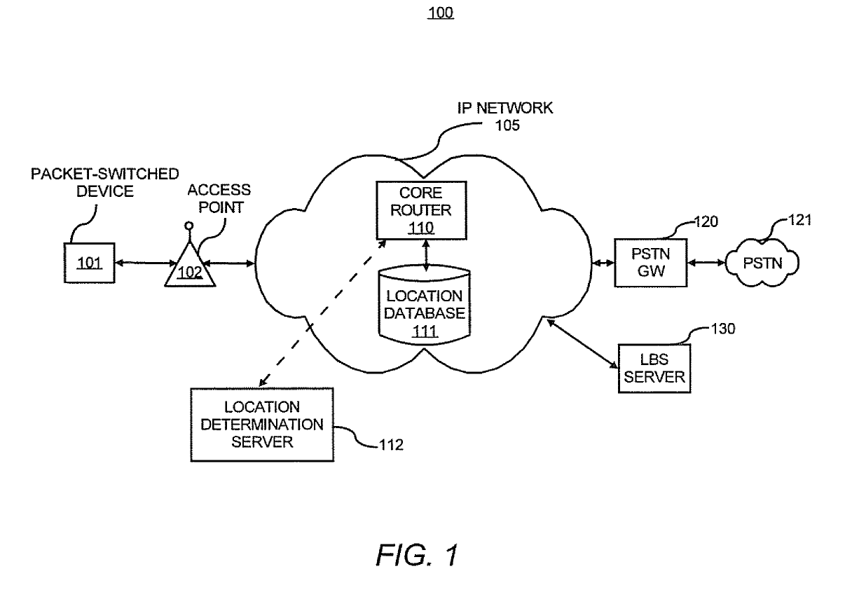

FIG. 1 illustrates a system 100, according to an embodiment. The system 100 shows a packet-switched device 101 connected to an IP network 105 via an access point 102. The access point 102 is typically a stationary device at a predetermined location that provides access to an IP network, such as the IP network 105. The access point 102 may be part of an access network, such as a WiFi or WiMAX access network, for accessing the IP network 105. The IP network 105 may include the Internet or other public and/or private networks.

The access point 102 inserts a tag in a message transmitted from the packet-switched device 101. The message is received by a core router 110 in the IP network 105. The core router 110 is a device in the IP network 105. The core router 110 may be included in an Internet service provider's network, which may be part of the IP network 105. The core router 110 parses the message to identify the tag. The tag is used to perform a lookup in a location database 111 to determine the location of the packet-switched device 101. For example, the location database 111 stores tags and a corresponding location for each tag. The locations are the geographic locations of access points. Thus, each access point that is operable to insert a tag for determining location in a message from a packet-switched device has a corresponding location stored in the location database 111. Thus, the location determined from the lookup performed on the location database 111 is the geographic location of the access point 102, which is used as an estimation of the location of the packet-switched device 101.

The location determined using the tag may be used to route the message and/or provide location-based services for the packet-switched device 101. For example, the location and possibly the message are sent to a location-based services (LBS) server 130, and the LBS server provides location-based information to the packet-switched device 101. One example of a location-based service may include providing advertisement, promotional services, or other information relevant to the location of the packet-switched device 101 to the packet-switched device 101. For example, the LBS server 130 may provide a list of restaurants in the vicinity of the packet-switched device 101. In another example, where the user of the packet-switched device 101 is making a “911” call, the location and message may be sent to a packet-switched gateway 120, which forwards the location and message via a packet-switched 121 to a “911” call center based on the location.

The core router is one example of a device that may be used to determine a location of the packet-switched device 101. Other types of devices, which may be in the IP network 105 or outside the IP network 105, can alternatively or also be used to determine the location of the packet-switched device 101. In one embodiment, instead of the core router 110 determining a location for the packet-switched device 101, another device outside the IP network 105 determines the location. For example, the core router 110 forwards the message, including the tag, from the packet-switched device 101 and the access point 102 to a location determination server 112. The location determination server 112 may include a location database similar to the location database 111 described above. The location determination server 112 uses the tag to perform a lookup to determine the location for the packet-switched device 101. The location determination server 112 may send the location information to the core router 110, and the core router 110 performs routing or forwards the message and location to an LBS server to provide location-based services for the packet-switched device 101.

As described above, the access point 102 may be part of an access network that provides a packet-switched device with access to another network, such as the IP network 105, so the packet-switched device may communicate with another device. Typically, the location of access points are known, and the locations of the access points are stored in the location database 111 along with corresponding access points tags, which may be access point IDs or any information that is unique to a particular access point. Even, if the location of some access points are initially not known, many access points may be GPS enabled, and these access points may be queried for their locations.

Also, as described above, the core router 110 or another device connected to a location database estimates the location of a packet-switched device based on the location of an access point used by the packet-switched device to access a network. The accuracy of the estimation of the location of the packet-switched device is based on how close the packet-switched device is to the access point. In some instances, this location estimation may be accurate within 100 meters. For example, WiMAX access points are supposed to be within 100 meters of a device using the access point according to WiMAX standards. This 100 meter restriction also happens to be the same restriction for “911” services. For example, a “911” call center should be able to determine a person's location within 100 meters.

More generally, the accuracy of the location estimation may be based on the range of the access point and the packet-switched device. For example, if an access point has a 1-mile range, than the location estimation may be accurate within one mile. Also, accuracy of the location estimation may be based on the particular access point that inserting the tag used to determine the location. For example, FIG. 1 shows a single access point 102 between the packet-switched device 101 and the IP network 105. However, multiple access points may be provided between the packet-switched device 101 and the IP network 105. If the access point closest to the packet-switched device 101 inserts the tag used to determine the location, then the location estimation may be more accurate. The closest access point may be the first access point encountered for a communication transmitted from the packet-switched device 101, which is also the last access point before reaching the packet-switched device 101 when the packet-switched device 101 is receiving a communication. Another factor that may affect location accuracy is how long it takes the core router 110 to determine the location, especially if the packet-switched device 101 is moving. However, location estimation according to the embodiments may be performed in real-time to improve accuracy.

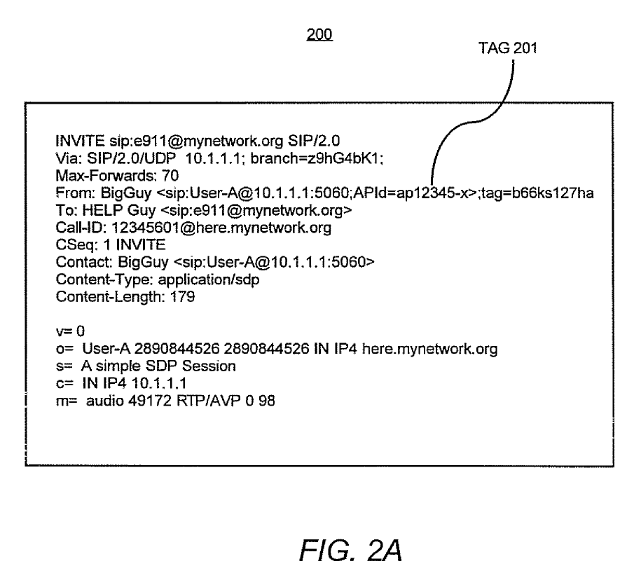

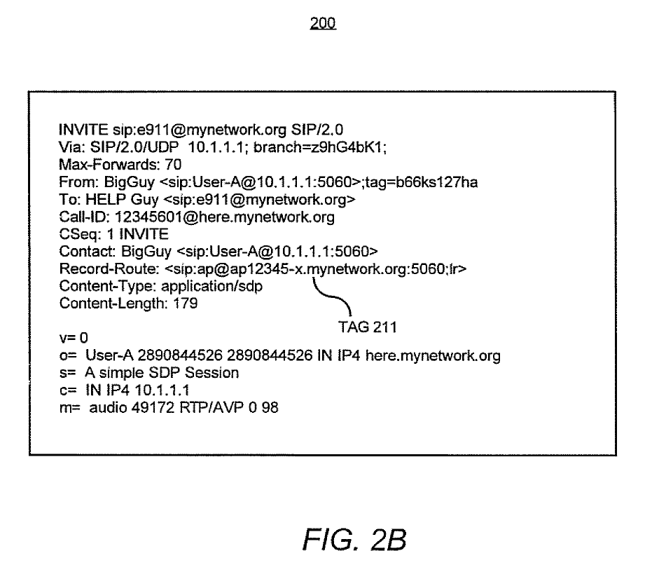

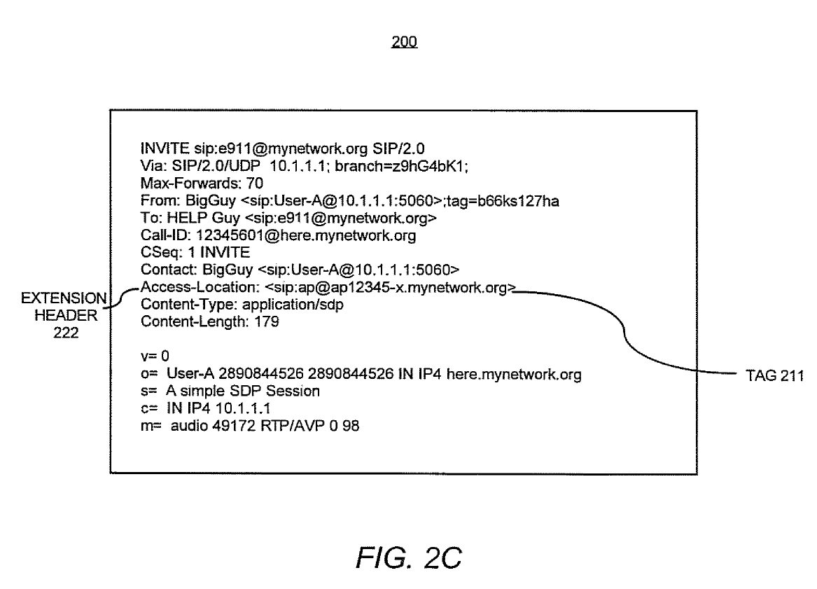

As described above, the access point 102 inserts a tag in the message from the packet-switched device 101 and this tag is used to query the location database 111 to determine the location of the packet-switched device 101. The tag is may be information that is unique to the access point 102. In one example, the tag is an access point ID for the access point 102, and the tag is inserted in a Session Initiation Protocol (SIP) invite transmitted from the packet-switched device 101. FIGS. 2A-C illustrate examples of tags inserted in a message, where the tag is an access point ID and the message is a SIP invite. It will be apparent to one of ordinary skill in the art that the embodiments described herein are applicable to protocols other than SIP that are used for communication between the packet-switched device 101 and other devices.

FIG. 2A shows a tag 201 in a SIP invite 200 transmitted, for example, from the packet-switched device 101. The SIP invite is one example of the message referred to above, which is transmitted from the packet-switched device 101. The access point 102 receives the SIP invite 200 and inserts the tag 201 in the invite. The tag 201 is an ID for the access point 102 and is shown as “ap12345-x”. The tag 201, in this example, is inserted in the “From” field in the SIP invite header. The other information shown in FIG. 2A includes fields and information typically provided in a SIP invite. The “From” field is a mandatory field in a SIP invite and is read by any device receiving the invite. The tag 201 may be inserted in other mandatory fields.

In another example, the tag is inserted in a non-mandatory field in the SIP invite 200. FIG. 2B shows a tag 221 inserted in the “Record-Route” field, which is a non-mandatory field. The “Record-Route” field is non-mandatory, because it may be used or read by all devices receiving the invite. The tag 211 is “ap12345-x.mynetwork.org”. The tag 211, like the tag 201, is a unique identifier for the access point 102, and is used to perform a lookup on the database 111 to determine the corresponding location.

In another example, a new field is added to the SIP invite 200, and the tag is inserted in the new field. FIG. 2C is shows a new field, referred to as an extension header 222, in the invite 200. The extension header 222 is given the title “Access-Location”. In this example, the tag 211 is inserted in the extension header 222.

Any of the examples shown in FIGS. 2A-C may be used to insert the tag in the message, which is a SIP invite in these examples. The core router 110 predetermines which technique is used for inserting the tag, and parses the SIP invite to identify the tag in the predetermined location in the SIP invite.

It will be apparent to one of ordinary skill in the art that the system 100 shown in FIG. 1 may include many access points at many different locations. Also, the system 100 may include many core routers operable to determine the location of a packet-switched device and many servers performing other functions and many packet-switched devices.

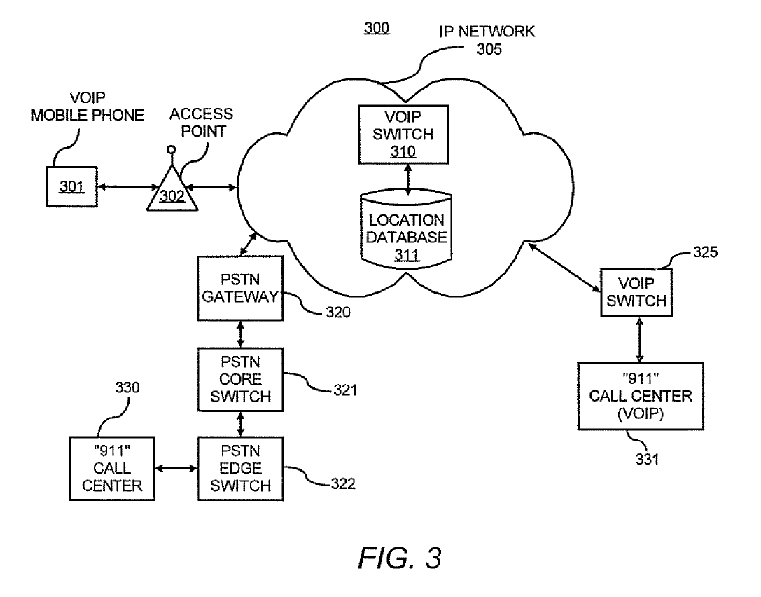

FIG. 3 illustrates a system 300 for providing “911” service according to an embodiment. The system 300 is essentially the same as the system 100, except the system 300 shows the different paths that may be taken by a VoIP “911” call. The system 300 includes a packet-switched device that is a VoIP mobile phone 301. The VoIP mobile phone 301 makes a “911” call. To make the “911” call, the VoIP mobile phone 301 sends a SIP invite to a “911” call center. The SIP invite is received at the access point 302. The access point 302 inserts a tag in the SIP invite, for example, using one of the techniques shown in FIGS. 2A-C. A VoIP switch 310 is connected to a location database 311. The VoIP switch 310 may be a core router in the IP network 305.

The VoIP switch 310 receives the SIP invite with the tag inserted by the access point 302. The VoIP switch 310 performs a lookup on the location database 311 to determine the corresponding location for the tag. The location database 311 may also location information for “911” call centers. The VoIP switch 310 may also perform a lookup on the database 311 using the corresponding location to identify the closest “911” call center to the VoIP mobile phone 301. For example, if the call center 330 is closest to the location determined using the tag in the SIP invite, the call is routed to the call center 330 via the packet-switched gateway 320, the packet-switched 321, and the packet-switched edge switch 322. If the call center 331 is closest to the location determined using the tag in the SIP invite, the call is routed to the call center 331 via the VoIP switch 325. Note the call center 331 is a VoIP call center operable to send and receive VoIP calls. After the SIP invite is received by the appropriate call center, a session is established so the VoIP call data is transferred to the call center.

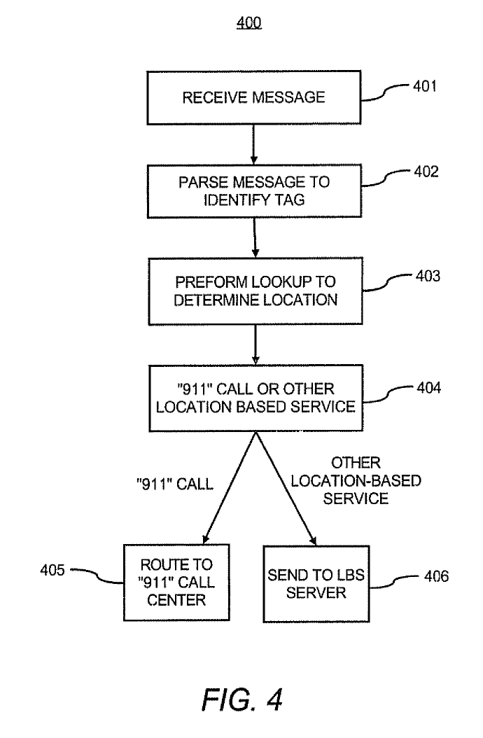

FIG. 4 illustrates a method 400 for determining a location of a packet-switched device and providing location-based services to the packet-switched device, according to an embodiment. The method 400 is described with respect to one or more of FIGS. 1-3 by way of example and not limitation. The method 400 may be practiced in other systems.

At step 401, a device receives a message. The message was initially transmitted by a packet-switched device, such as the packet-switched device 101 shown in FIG. 1. Also, the message includes a tag inserted by an access point, such as the access point 102 shown in FIG. 1, between the packet-switched device 101 and the IP network 105, also shown in FIG. 1. The message may be a message for establishing a session to communicate with another device. For example, the message may be a SIP invite including a tag, such as described with respect to FIGS. 2A-C.

At step 402, the device parses the message to identify the tag. The device may be a device in the IP network 105 connected to the location database 111, such as the core router 110 shown in FIG. 1. Alternatively, the device may be outside the IP network 105, such as the location determination server 112. The device parses the message to find the tag, which may be inserted in a predetermined location in the message.

At step 403, the device performs a lookup in a location database using the tag to determine a corresponding location. For example, the device queries the location database 111 with the tag to determine the corresponding stored location for the tag. This location is an estimation of the location of the packet-switched device transmitting the message.

At step 404, the device determines whether the message is for a “911” call or another type of location-based service.

If the message is for a “911” call, the device determines the closest call center to the packet-switched device at step 404. At step 405, the device routes the message to the closest call center. For example, as shown in FIG. 3, the VoIP switch 310 determines the call center 330 is the closest call center based on the location determined at step 403, and routes the call to the call center 330.

If the message invokes another type of location-based service, then at step 406 the device may send the location determined at step 403 to the LBS server 130 shown in FIG. 1 to provide a location-based service.

It should be noted that the location database 111 and 311 may store entries during an initialization phase. Each of the entries may include but are not limited to a tag and a corresponding location for the tag. As new access points are deployed or access points are removed, the location database is updated.

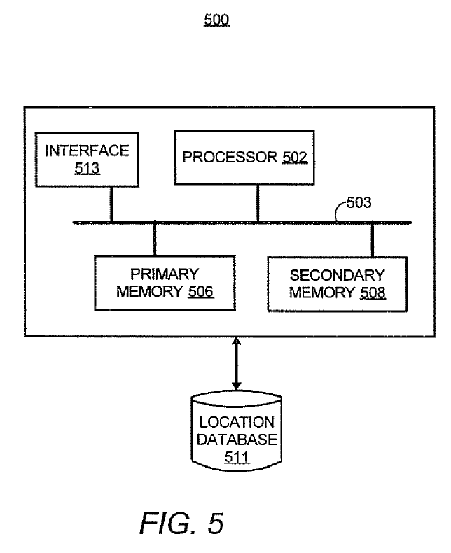

FIG. 5 illustrates a block diagram of a general purpose computer system 500 that is operable to be used as a platform for the device described with respect to the method 400. For example, the device may include a core router or a server connected to a location database.

The system 500 includes a processor 502, providing an execution platform for executing software. Commands and data from the processor 502 are communicated over a communication bus 503. The system 500 also includes a main memory 506, such as a Random Access Memory (RAM), where software may reside during runtime, and a secondary memory 508. The secondary memory 508 may include, for example, a nonvolatile memory where a copy of software is stored. In one example, the secondary memory 508 also includes ROM (read only memory), EPROM (erasable, programmable ROM), EEPROM (electrically erasable, programmable ROM).

The system 500 also includes a communication interface 513 for communicating with other devices. The communication interface 513 may be a wired or a wireless interface. The communication interface 513 may be a network interface.

The system 500 may include or be connected to a location database 511 (e.g., the location database 111 or 3 11 shown in FIGS. 1 and 3 respectively) storing tags and corresponding locations for the tags. The processor is operable to parse messages received via the interface 513 to identify a tag and perform a lookup on the location database 511 using the tag to determine a corresponding location. The location is an estimation of a location of a packet-switched device sending the message.

One or more of the steps in the method 400 and other steps described herein are operable to be implemented as software stored on a computer readable medium, such as the memory 506 and/or 508, and executed on the system 500, for example, by the processor 502.

The steps are operable to be embodied by a computer program, which can exist in a variety of forms both active and inactive. For example, they exist as software program(s) comprised of program instructions in source code, object code, executable code or other formats for performing some of the steps. The codes described above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A device operable to determine location of a packet-switched device, whereby the location is operable to be used to provide location-based services for the packet-switched device, the device comprising:
an interface receiving a message, wherein the message includes a tag inserted by an access point between the packet-switched device and the device;
a database storing a plurality of tags and a location for each tag; and
a processor parsing the message to identify the tag, and performing a lookup on the database using the tag to determine a corresponding location for the tag, wherein the location is an estimation of a location of the packet-switched device and the location is operable to be used to provide a location-based service for the packet-switched device.

2. The device of claim 1, wherein the corresponding location for the tag is a location of the access point inserting the tag in the message.

3. The device of claim 2, wherein the access point is in an access network between the packet-switched device and an IP network, and the access point is a first point of access for the packet-switched device.

4. The device of claim 2, wherein the tag is a unique identifier for the access point.

5. The device of claim 1, wherein the message comprises a message for establishing a session using a conversational protocol.

6. The device of claim 5, wherein the message comprises a SIP invite.

7. The device of claim 6, wherein the tag is inserted in a mandatory field in a header of the SIP invite, a non-mandatory field in the header of the SIP invite, or in an extension header in the SIP invite.

8. The device of claim 1, wherein the device is a core router in a service provider's network.

9. The device of claim 1, wherein the device is a server outside a service provider's network.

10. A method for estimating a location of a packet-switched device, wherein the location is operable to be used to provide a location-based service for the packet-switched device, the method comprising:
receiving a message at a device, wherein the message includes a tag inserted by an access point between the packet-switched device and the device;
parsing the message to identify the tag; and
performing a lookup using the tag to determine a corresponding location, wherein the location is an estimation of a location of the packet-switched device and is operable to be used to provide a location-based service for the packet-switched device.

11. The method of claim 10, wherein performing a lookup comprises:
querying a database with the tag to retrieve the corresponding location for the tag.

12. The method of claim 11, further comprising storing tags and a corresponding location for each tag in the database, wherein the stored tags and corresponding locations include the tag inserted in the message and the corresponding location for the tag retrieved from the database.

13. The method of claim 12, wherein the locations comprises locations of access points.

14. The method of claim 12, wherein the tags comprise unique identifiers for the access points.

15. The method of claim 10, wherein the access point is in an access network between the packet-switched device and an IP network.

16. The method of claim 10, wherein the message comprises a message for establishing a session using a conversational protocol.

17. The method of claim 16, wherein the message comprises a SIP invite.

18. The method of claim 17, wherein the tag is inserted in a mandatory field in a header of the SIP invite, a non-mandatory field in the header of the SIP invite, or in an extension header in the SIP invite.

19. A method for estimating a location of a packet-switched device, wherein the location is operable to be used to provide “911” service for the packet-switched device, the method comprising:
receiving a message at a device, wherein the message includes a tag inserted by an access point between the packet-switched device and the device;
parsing the message to identify the tag;
performing a lookup using the tag to determine a corresponding location, wherein the location is an estimation of a location of the packet-switched device; and
sending the message to a “911” call center, wherein the estimation of the location of the packet-switched device is operable to be used to provide “911” service for the packet-switched device.

20. The method of claim 19, further comprising:
determining a “911” call center closest to the packet-switched based on the corresponding location; and
sending the message to a “911” call center comprises sending the message to the “911” call center determined to be closest to the packet-switched device.
